(19) United States
(12) Patent Application Publication
(10) Pub. No.: US 2022/0066058 A1
(43) Pub. Date: Mar. 3, 2022

(54) landslide Deep Displacement Remote Visual Monitoring System

(71) Applicants: Jianjun Gan, Nanchang (CN); Jianhua Li, Nanchang (CN); Xiaoming Li, Nanchang (CN)

(72) Inventors: Jianjun Gan, Nanchang (CN); Jianhua Li, Nanchang (CN); Xiaoming Li, Nanchang (CN)

(21) Appl. No.: 17/092,359

(22) Filed: Nov. 9, 2020

(30) Foreign Application Priority Data
Sep. 2, 2020 (CN) 202010911849.X

(51) Int. Cl. G01V 1/00; G01V 1/20; G01V 1/34; G08B 21/10; H04W 4/90

(52) U.S. Cl. CPC G01V 1/008; G01V 1/003; H04W 4/90; G01V 1/34; G08B 21/10; G01V 1/202

(57) ABSTRACT

The invention discloses a landslide deep displacement remote visual monitoring system, comprising monitoring system and transmitting system, the monitoring system comprises displacement sensor, the displacement sensor is arranged on chassis, anchor eyes are provided on the chassis, wire embedding hole is arranged at centroid of the chassis, multiple bracing wires are provided in the wire embedding hole, the transmitting system comprises a data acquisition unit, the data acquisition unit is arranged on the displacement sensor for collecting data thereof, the data acquisition unit is connected to a network transmission module, the network transmission module is connected to a data receiving module through the network, the data receiving module is also provided with network transmission module, the data receiving module is connected to computer, the computer displays the data through display screen.

### BACKGROUND OF THE INVENTION

### 1. Field of the Invention

The invention relates to landslide monitoring device, in particular to a landslide deep displacement remote visual monitoring system.

### 2. Description of the Related Art

Landslide refers to a natural phenomenon that the soil or rock mass on the slope, affected by river degradation, groundwater activity, rainwater soaking, earthquake and artificial slope cutting, slides down the slope integrally or dispersedly under the action of gravity and along a certain weak surface or weak zone. The moving soil or rock mass is called displacement body or slipping body, the unmoved underlying soil or rock mass is called slide bed.

Landslide monitoring belongs to discipline of natural disasters and prevention for observing and analyzing various landslide precursor phenomena and recording various tasks of landslide formation activities. Various crack development processes in different parts of the slope, rock and soil mass relaxation and partial collapse, sedimentation and uplift activities; various underground and ground deformation and displacement phenomena; groundwater level, water volume, and hydrochemical characteristics; trees tilt and various building deformations; rainfall and various changes in the external environment such as earthquake activity; abnormal animal activities. Through these tasks, relevant data and information are obtained to provide a basis for landslide forecasting and disaster prevention.

In addition to general surface surveys and macroscopic observation, a variety of instruments are used for observation and recording. Commonly used are tilt meters for measuring the displacement of landslide bodies and the development of cracks, as well as strain meters, seismometers, geophones, and geoelectric meters. Various monitoring methods cooperate with each other to form a relatively complete stereoscopic monitoring system.

However, the prior monitoring system cannot perform remote visual real-time monitoring, and requires local monitoring points to be built for monitoring, which cannot be centralized management and consumes too much manpower.

### SUMMARY OF THE INVENTION

The invention aims to solve above technical problems by providing a landslide deep displacement remote visual monitoring system.

In order to solve above technical problems, the invention provides the following technical schemes: a landslide deep displacement remote visual monitoring system, comprising monitoring system and transmitting system, wherein the monitoring system comprises displacement sensor, the displacement sensor is arranged on chassis, anchor eyes are provided on the chassis, wire embedding hole is arranged at centroid of the chassis, multiple bracing wires are provided in the wire embedding hole, a dust protection cover is provided on outer side of the displacement sensor, anchor points are provided on the end of the bracing wires far away from the displacement sensor, and the length of the multiple bracing wires is different, the distribution angle of the anchor points is not limited, and the embedded depth of the anchor points is different, a solar panel is arranged on the surface of the chassis to supply power to the displacement sensor, the transmitting system comprises a data acquisition unit, the data acquisition unit is arranged on the displacement sensor for collecting data thereof, the data acquisition unit is connected to a network transmission module, the network transmission module is connected to a data receiving module through the network, the data receiving module is also provided with network transmission module, the data receiving module is connected to center control computer, the control center computer displays the data, and the control center computer is connected to management center computer, the control center computer is used for cellphone data, and the management center computer is used for managing the control center computer, the control center computer is connected to operators' network and sends message alert through operators' network.

Compared to the prior art, the advantages of the invention are: the invention can transmit the locally collected landslide monitoring data to the computer in real time for visualized management of the data, and relevant software can be customized for computer manual supervision in the later stage, the double insurance can realize monitoring the data in real time and can reduce the landslide accidents caused by human monitoring errors, moreover, remote management can gather the data of multiple monitoring points in one place for centralized management, avoiding the waste of manpower and material resources caused by the construction of monitoring points in monitoring sites.

As an improvement, the anchor points are used for fixing and changing resistance, and can realize the reading of displacement parameters, there is no need for prefabricated wells, the overall parameters of the landslide can be collected and the displacement parameters of multiple points can be collected, thereby the displacement situation of each point can be effectively monitored, and the safety factor is higher.

As an improvement, the data acquisition unit is arranged on the displacement sensor through wires to collect data acquired by the displacement sensor and send the same through network transmission module, the network transmission module adopts 4G and 5G to transmit, which can guarantee transmission distance and transmission quality, 4G and 5G are transmitted data through the Internet, which can ensure transmission efficiency, speed and distance, and real-time monitoring can also be carried out in remote places, avoiding excessive infrastructure waste of manpower and material resources.

As an improvement, after receiving data, the data receiving module is directly connected to the computer through the data cable to input the date directly, and the computer can display and convert the data image through the post-customized software after receiving the data, and convert the data into an intuitive visual picture such as a line graph, which makes the reading more efficient.

### BRIEF DESCRIPTION OF THE DRAWINGS

FIG. 1 shows the structure of a landslide deep displacement remote visual monitoring system.

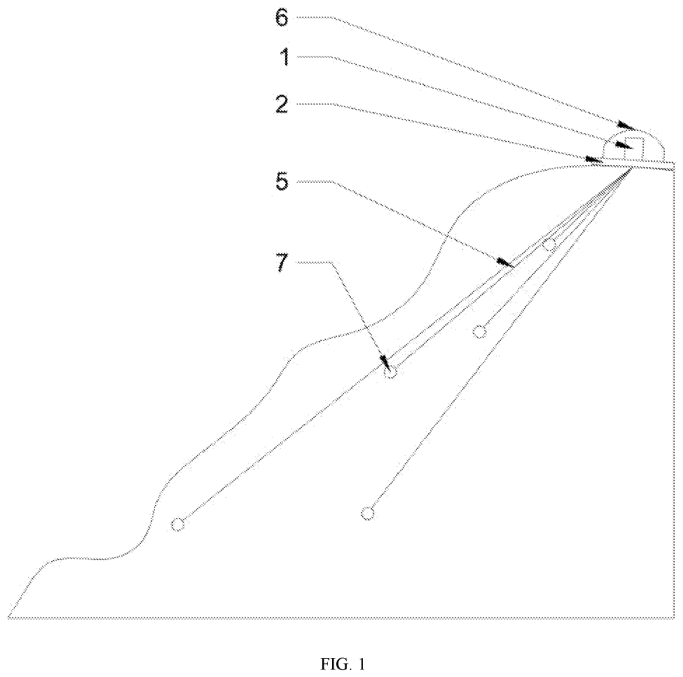

FIG. 2 shows the system structure of a landslide deep displacement remote visual monitoring system.

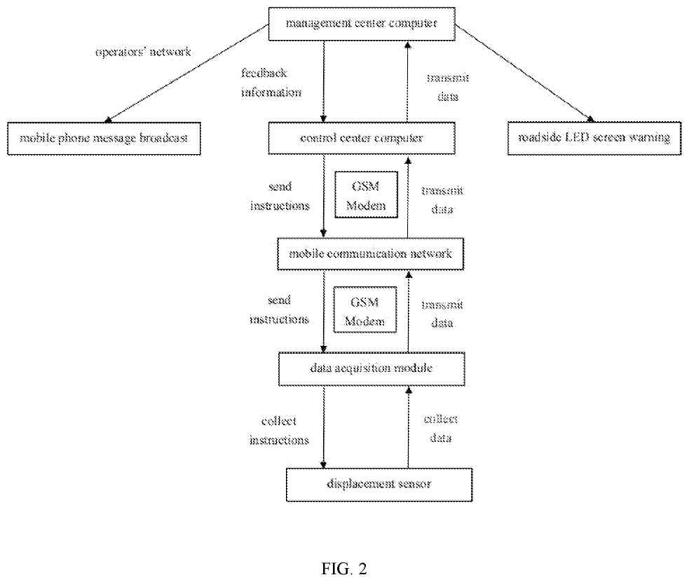

FIG. 3 shows the chassis structure of a landslide deep displacement remote visual monitoring system.

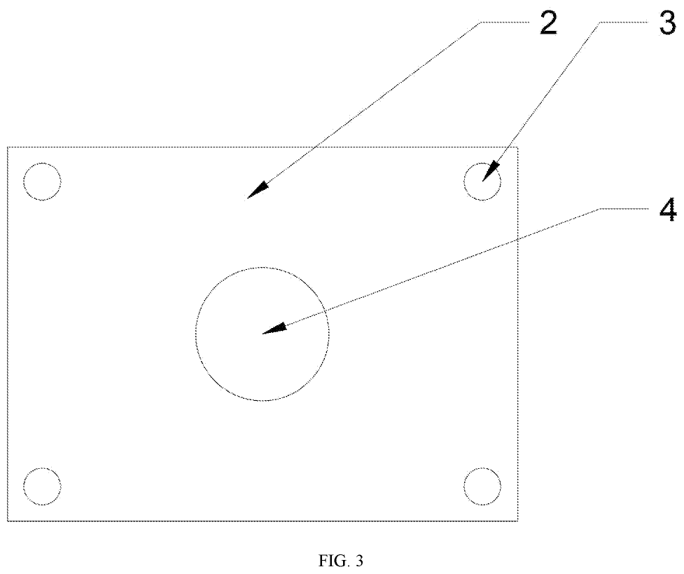

In the accompanying drawings, 1 refers to displacement sensor, 2 refers to chassis, 3 refers to anchor eye, 4 refers to wire embedding hole, 5 refers to bracing wire, 6 refers to dust protection cover, 7 refers to anchor point.

### DETAILED DESCRIPTION OF THE PREFERRED EMBODIMENTS

The invention is further described in detail with reference to the accompanying drawings.

In specific embodiment, a landslide deep displacement remote visual monitoring system, comprising monitoring system and transmitting system, wherein the monitoring system comprises displacement sensor 1, the displacement sensor 1 is arranged on chassis 2, anchor eyes 3 are provided on the chassis 2, wire embedding hole 4 is arranged at centroid of the chassis 2, multiple bracing wires 5 are provided in the wire embedding hole 4, a dust protection cover 6 is provided on outer side of the displacement sensor 1, anchor points 7 are provided on the end of the bracing wires 5 far away from the displacement sensor 1, and the length of the multiple bracing wires 5 is different, the distribution angle of the anchor points 7 is not limited, and the embedded depth of the anchor points 7 is different, a solar panel is arranged on surface of the chassis 2 to supply power to the displacement sensor 1, the transmitting system comprises a data acquisition unit, the data acquisition unit is arranged on the displacement sensor for collecting data thereof, the data acquisition unit is connected to a network transmission module, the network transmission module is connected to a data receiving module through the network, the data receiving module is also provided with network transmission module, the data receiving module is connected to center control computer, the control center computer displays the data, and the control center computer is connected to management center computer, the control center computer is used for cellphone data, and the management center computer is used for managing the control center computer, the control center computer is connected to operators' network and sends message alert through operators' network.

The anchor points 7 are used for fixing and changing resistance, and can realize the reading of displacement parameters, there is no need for prefabricated wells, the overall parameters of the landslide can be collected and the displacement parameters of multiple points can be collected, thereby the displacement situation of each point can be effectively monitored, and the safety factor is higher.

The data acquisition unit is arranged on the displacement sensor through wires to collect data acquired by the displacement sensor and send the same through network transmission module, the network transmission module adopts 4G and 5G to transmit, which can guarantee transmission distance and transmission quality, 4G and 5G are transmitted data through the Internet, which can ensure transmission efficiency, speed and distance, and real-time monitoring can also be carried out in remote places, avoiding excessive infrastructure waste of manpower and material resources.

After receiving data, the data receiving module is directly connected to the computer through the data cable to input the date directly, and the computer can display and convert the data image through the post-customized software after receiving the data, and convert the data into an intuitive visual picture such as a line graph, which makes the reading more efficient.

The message transceiver system is directly controlled through the interface of the mountain torrent disaster warning software, and the short message group sending function is automatically triggered when an abnormal situation occurs. Automatic early warning release information and response instructions are sent to the responsible department and the person in charge through the message server of the monitoring center, and feedback from the department and personnel can be received in real time. Managers release information based on the receipt of messages, carry out remote operation instructions, and use the short message group sending interface provided by the operator to send early warning messages to the people living in the vicinity of the disaster point, carry out mass transfer, and protect the personal safety and property safety of the people.

LED screens for warning are arranged on both sides of the road next to the landslide, on the expressway, notice is arranged three kilometers in advance, and a screen is placed every one kilometer, on normal village roads and urban roads, notice is arranged 500 meters front of the landslide, if there is a landslide or there is a risk of landslides, the information is transmitted through the management center computer and posted on the LED screens to remind the passing pedestrians and vehicles to slow down and drive carefully or take a detour in advance to protect the personal safety and property safety of the masses.

The operating principle of the invention: monitoring is performed through multiple anchor points embedded in the monitoring slope, the real-time data is collected by displacement sensors into electrical signals, collected through data acquisition unit, transmitted through the Internet, and transmitted to another network transmission module to transmit network signals into the data receiver, then convert into data and input into the computer to form real-time monitoring, thereby the data can be displayed in front of people intuitively and visually through the display screen, the collected data is converted into a visual line graph through customized special software to intuitively analysis.

The mountain vibration, line graph and other factual information collected by the front-end equipment are collected in the monitoring software of the county-level monitoring center, and the data collected by the field equipment is analyzed and processed, and then the data is saved in the database of the monitoring software for future data analysis and comparison. Since the system adopts a multi-level management method, the county-level monitoring center shares the real-time collected data to the municipal monitoring center and the provincial monitoring center, thereby realizing the linkage of mountain torrent monitoring information, and the managers of all levels of government departments can make corresponding emergency decisions.

Although the embodiments of the invention are described above, it should be understood that the above embodiments are exemplary, and cannot be understood as the limitations to the invention, any changes, modification, replacements and variations, without departing from the principle and purpose of the invention and within the protection scope of the invention, can be made by those skilled in the art.

1. A landslide deep displacement remote visual monitoring system, comprising monitoring system and transmitting system, wherein the monitoring system comprises displacement sensor (1), the displacement sensor (1) is arranged on chassis (2), anchor eyes (3) are provided on the chassis (2), wire embedding hole (4) is arranged at centroid of the chassis (2), multiple bracing wires (5) are provided in the wire embedding hole (4), a dust protection cover (6) is provided on outer side of the displacement sensor (1), anchor points (7) are provided on the end of the bracing wires (5) far away from the displacement sensor (1), and the length of the multiple bracing wires (5) is different, the distribution angle of the anchor points (7) is not limited, and the embedded depth of the anchor points (7) is different, a solar panel is arranged on surface of the chassis (2) to supply power to the displacement sensor (1), the transmitting system comprises a data acquisition unit, the data acquisition unit is arranged on the displacement sensor for collecting data thereof, the data acquisition unit is connected to a network transmission module, the network transmission module is connected to a data receiving module through the network, the data receiving module is also provided with network transmission module, the data receiving module is connected to center control computer, the control center computer displays the data, and the control center computer is connected to management center computer, the control center computer is used for cellphone data, and the management center computer is used for managing the control center computer, the control center computer is connected to operators' network and sends message alert through operators' network.

2. The landslide deep displacement remote visual monitoring system of claim 1, wherein the anchor points (7) are used for fixing and changing resistance, and can realize the reading of multi-angle displacement parameters.

3. The landslide deep displacement remote visual monitoring system of claim 1, wherein the data acquisition unit is arranged on the displacement sensor through wires to collect data acquired by the displacement sensor and send the same through network transmission module, the network transmission module adopts 4G, 5G, GSM Modem to transmit, which can guarantee transmission distance and transmission quality.

4. The landslide deep displacement remote visual monitoring system of claim 1, wherein after receiving data, the data receiving module is directly connected to the computer through the data cable to input the date directly.
